(19) United States
(12) Patent Application Publication
(10) Pub. No.: US 2026/0314683 A1
(43) Pub. Date: Oct. 15, 2026

(54) AEROSOL-GENERATING DEVICE

(71) Applicant: KT&G CORPORATION, Daejeon (KR)

(72) Inventors: Daenam HAN, Seoul (KR); Hwikyeong AN, Seoul (KR)

(73) Assignee: KT&G CORPORATION, Daejeon (KR)

(21) Appl. No.: 19/718,127

(22) Filed: Jun. 24, 2026

Related U.S. Application Data
(63) Continuation of application No. 18/723,643, filed on Dec. 23, 2022.

(30) Foreign Application Priority Data
Dec. 30, 2021 (KR) 10-2021-0193479

(51) Int. Cl. A24F 40/465; A24D 1/20; A24F 40/20; H05B 6/10

(52) U.S. Cl. CPC A24F 40/465; A24D 1/20; A24F 40/20; H05B 6/108

(57) ABSTRACT

An aerosol-generating device is disclosed. The aerosol-generating device of the disclosure includes a pipe shaped to define an insertion space; a flange covering a bottom of the insertion space; a heater rod coupled to the flange, wherein the heater rod is elongated and protrudes into the insertion space; a heater disposed in the heater rod and being configured to heat the insertion space, wherein the heater rod is shaped to include an insulation space that it located below the heater.

### CROSS-REFERENCE TO RELATED APPLICATIONS

This application is a continuation of U.S. Patent Application No. 18/723,643, filed on Jun. 24, 2024, which is the National Stage filing under 35 U.S.C. 371 of International Application No. PCT/KR2022/021204, filed on Dec. 23, 2022, which claims the benefit of earlier filing date and right of priority to Korean Application No. 10-2021-0193479, filed on Dec. 30, 2021, the contents of which are all hereby incorporated by reference herein in their entireties.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### Disclosure

### TECHNICAL PROBLEM

It is an object of the present disclosure to solve the above and other problems.

It is another object of the present disclosure to prevent heat generated from a heater from thermally deforming peripheral components and to improve the structural stability of the peripheral components.

It is still another object of the present disclosure to prevent heat generated from a heater from heating an unnecessary portion of a stick and to prevent leakage of a carbide or a medium from the stick.

It is still another object of the present disclosure to increase power efficiency by causing a heater to heat only a necessary portion.

### TECHNICAL SOLUTION

In accordance with an aspect of the present disclosure for accomplishing the above objects, there is provided an aerosol-generating device including a pipe shaped to define an insertion space; a flange covering a bottom of the insertion space; a heater rod coupled to the flange, wherein the heater rod is elongated and protrudes into the insertion space; a heater disposed in the heater rod and being configured to heat the insertion space, wherein the heater rod is shaped to include an insulation space that it located below the heater.

### ADVANTAGEOUS EFFECTS

According to at least one of embodiments of the present disclosure, it may be possible to prevent heat generated from a heater from thermally deforming peripheral components and to improve the structural stability of the peripheral components.

According to at least one of embodiments of the present disclosure, it may be possible to prevent heat generated from a heater from heating an unnecessary portion of a stick and to prevent leakage of a carbide or a medium from the stick.

According to at least one of embodiments of the present disclosure, it may be possible to increase power efficiency by causing a heater to heat only a necessary portion.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### DESCRIPTION OF DRAWINGS

FIGS. 1 to 9 are views showing examples of an aerosol-generating device according to embodiments of the present disclosure.

### MODE OF INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes "module" and "unit" are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms "first", "second", etc., may be used herein to describe various components, these components should not be limited by these terms. These terms are only used to distinguish one component from another component.

It will be understood that when a component is referred to as being "connected to" or "coupled to" another component, it may be directly connected to or coupled to another component, or intervening components may be present. On the other hand, when a component is referred to as being "directly connected to" or "directly coupled to" another component, there are no intervening components present.

As used herein, the singular form is intended to include the plural forms as well, unless the context clearly indicates otherwise.

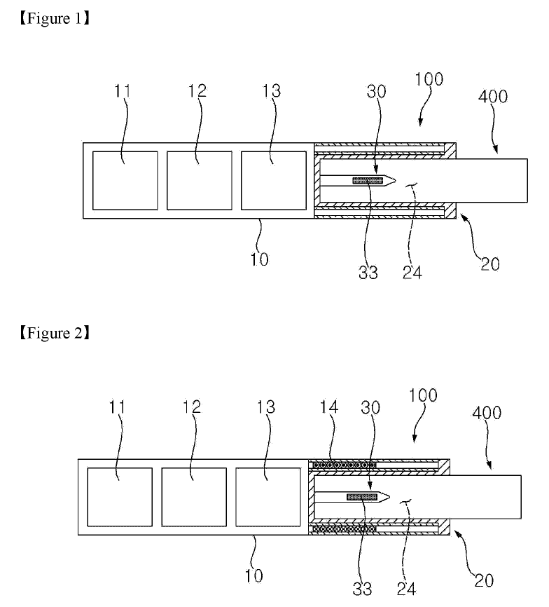

Referring to FIGS. 1 and 2, an aerosol-generating device 100 may include at least one of a battery 11, a controller 12, or a sensor 13. At least one of the battery 11, the controller 12, or the sensor 13 may be disposed in a lower body 10 of the aerosol-generating device 100.

An upper body 20 may be coupled to the upper end of the lower body 10, or may be coupled to the upper side of the lower body 10. The upper body 20 may have defined therein an insertion space 24 having an open top. A stick 400 may be inserted into the insertion space. The upper body 20 may be referred to as a pipe 20.

A heater rod 30 may be located in the insertion space 24. The heater rod 30 may protrude from the bottom of the insertion space 24 so as to be elongated in the insertion space 24. A heater 33 may be disposed in the heater rod 30. The heater 33 may be a resistive heater. The heater 33 may heat the insertion space 24.

When the stick 400 is inserted into the insertion space 24, one end of the stick 400 may be exposed to the outside of the upper body 20. When the stick 400 is inserted into the insertion space 24, the heater rod 30 may penetrate an end of the stick 400 to be inserted into the stick 400. The stick 400 may be heated by the heater 33 disposed in the heater rod 30. A user may hold an end of the stick 400, which is exposed to the outside, in the mouth to inhale air.

The battery 11 may supply power to operate components of the aerosol-generating device 100. The battery 11 may supply power to at least one of the controller 12, the sensor 13, an induction coil 14, or the heater rod 30. The battery 11 may supply power required to operate a display, a motor, etc. mounted in the aerosol-generating device 100.

The controller 12 may control the overall operation of the aerosol-generating device 100. The controller 12 may control the operation of at least one of the battery 11, the induction coil 14, or the sensor 13. The controller 12 may control the operation of the display, the motor, etc. mounted in the aerosol-generating device 100. The controller 12 may check the state of each of the components of the aerosol-generating device 100 to determine whether the aerosol-generating device 100 is in an operable state.

The sensor 13 may detect the temperature of the heater 33. The controller 12 may control the temperature of the heater 33 based on the temperature of the heater 33 detected by the sensor 13. The controller 12 may transmit information about the temperature of the heater 33 detected by the sensor 13 to the user through a user interface.

Referring to FIG. 1, the heater 33 may be electrically connected to the battery 11. The heater 33 may generate heat upon directly receiving current from the battery 11 without the necessity of the induction coil 14 (refer to FIG. 2).

Referring to FIG. 2, the aerosol-generating device 100 may include an induction coil 14 disposed around the insertion space 24 and the heater rod 30. The induction coil 14 may cause the heater 33 to generate heat. The heater 33 may be a susceptor. The heater 33 may generate heat due to a magnetic field generated by alternating current flowing through the induction coil 14. The magnetic field may pass through the heater 33 to generate an eddy current in the heater 33. The current may cause the heater 33 to generate heat.

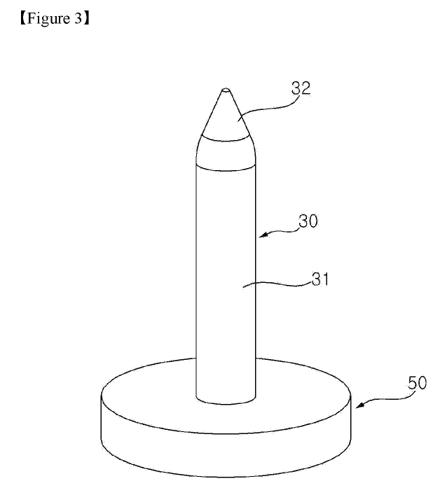

Referring to FIG. 3, the heater rod 30 may be elongated in the upward-downward direction. The heater rod 30 may include a body portion 31 and a head portion 32. The body portion 31 may have an elongated cylindrical shape. The head portion 32 may be formed on the upper end of the body portion 31. The head portion 32 may have a shape that gradually narrows toward the upper side thereof. The head portion 32 may have a pointed top. Accordingly, the heater rod 30 may be smoothly inserted into the stick 400 (refer to FIGS. 1 and 2).

A flange 50 may form the bottom of the insertion space 24 (refer to FIGS. 1 and 2). The lower end of the heater rod 30 may be fixed to the flange 50. The heater rod 30 may protrude upwards from the flange 50 so as to be elongated. For example, the flange 50 may have a plate shape. The flange 50 may be integrally formed with the heater rod 30 through insert injection molding.

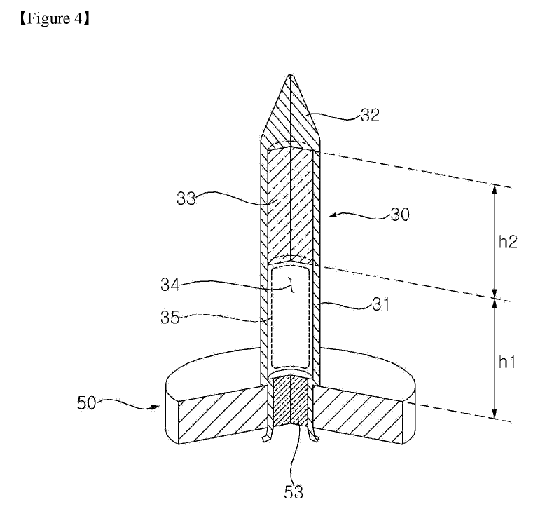

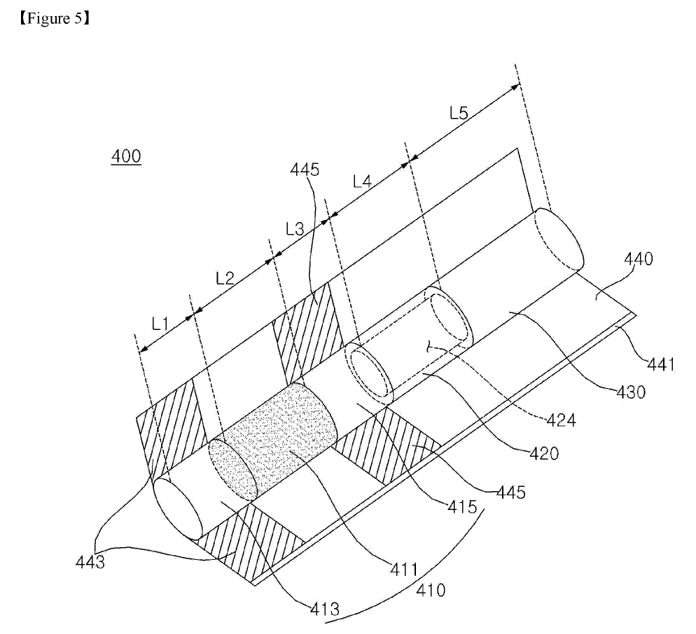

Referring to FIG. 4, the heater rod 30 may have a hollow shape. The heater 33 may be disposed in the heater rod 30. The heater 33 may be fixed to the interior of the heater rod 30 by means of an adhesive material. Alternatively, the heater rod 30 may be fixed to the heater 33 through insert injection molding. The body portion 31 and the head portion 32 of the heater rod 30 may define the space in the heater rod 30. The body portion 31 may surround the periphery of the heater 33. The head portion 32 may cover the upper end of the heater 33. The heater rod 30 may be formed of a ceramic material. Heat generated from the heater 33 may be transferred to the outside of the heater rod 30 to heat the stick 400 (refer to FIGS. 1 and 2).

An insulation space 34 may be defined in the heater rod 30. The insulation space 34 may be defined as an air layer. The insulation space 34 may have lower thermal conductivity than the heater rod 30. The periphery of the insulation space 34 may be surrounded by the body portion 31 of the heater rod 30. The insulation space 34 may be located under the heater 33. The upper end of the insulation space 34 may be in contact with the lower end of the heater 33. The lower end of the insulation space 34 may be open, or may be covered by a cover 53 or the flange 50. A heat absorber such as a phase change material may be inserted into the insulation space 34.

When a portion of the heat generated from the heater 33 passes through the insulation space 34, conduction of the heat may be reduced. That is, the insulation space 34 may reduce the amount of heat that is transferred from the heater 33 to the periphery of the insulation space 34. In addition, it may be possible to reduce thermal deformation of a coupling portion between the lower portion of the heater rod 30 and the flange 50 or the pipe 20 (refer to FIGS. 1 and 2) and to improve the structural stability thereof.

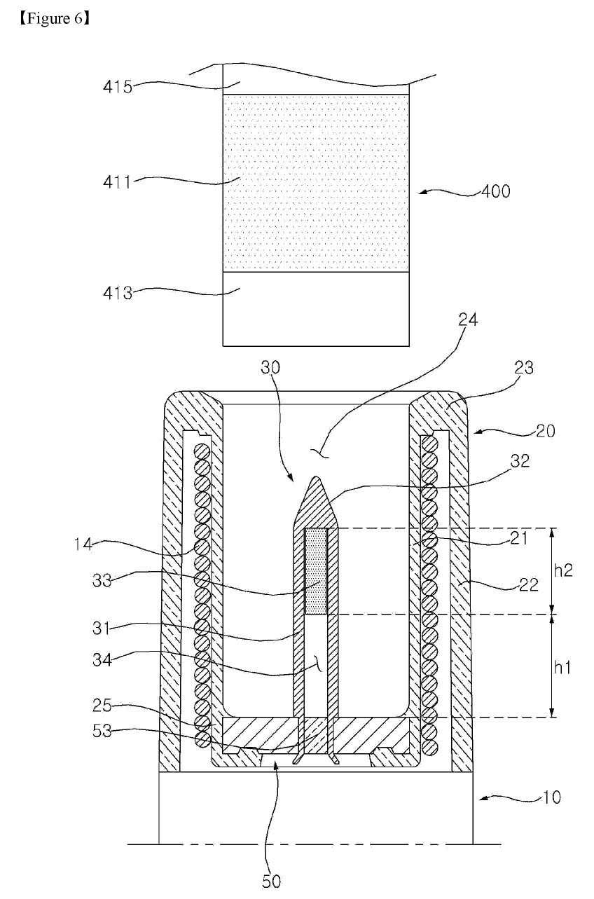

Referring to FIG. 5, the stick 400 may include a medium portion 410. The stick 400 may include a cooling portion 420. The stick 400 may include a filter portion 430. The cooling portion 420 may be disposed between the medium portion 410 and the filter portion 430. The stick 400 may include a wrapper 440. The wrapper 440 may wrap the medium portion 410. The wrapper 440 may wrap the cooling portion 420. The wrapper 440 may wrap the filter portion 430. The stick 400 may have a cylindrical shape.

The medium portion 410 may include a medium 411. The medium portion 410 may include a first medium cover 413. The medium portion 410 may include a second medium cover 415. The medium 411 may be disposed between the first medium cover 413 and the second medium cover 415. The first medium cover 413 may be disposed at one end of the stick 400. The medium portion 410 may have a length of 24 mm.

The medium 411 may contain a multicomponent substance. The substance contained in the medium may be a multicomponent flavoring substance. The medium 411 may be composed of a plurality of granules. Each of the plurality of granules may have a size of 0.4 mm to 1.12 mm. The granules may account for approximately 70% of the volume of the medium 411. The length L2 of the medium 411 may be 10 mm. The first medium cover 413 may be made of an acetate material. The second medium cover 415 may be made of an acetate material. The first medium cover 413 may be made of a paper material. The second medium cover 415 may be made of a paper material. At least one of the first medium cover 413 or the second medium cover 415 may be made of a paper material, and may be crumpled so as to be wrinkled, and a plurality of gaps may be formed between the wrinkles so that air flows therethrough. Each of the gaps may be smaller than each of the granules of the medium 411. The length L1 of the first medium cover 413 may be shorter than the length L2 of the medium 411. The length L3 of the second medium cover 415 may be shorter than the length L2 of the medium 411. The length L1 of the first medium cover 413 may be 7 mm. The length L2 of the second medium cover 415 may be 7 mm.

Accordingly, each of the granules of the medium 411 may be prevented from being separated from the medium portion 410 and the stick 400.

The cooling portion 420 may have a cylindrical shape. The cooling portion 420 may have a hollow shape. The cooling portion 420 may be disposed between the medium portion 410 and the filter portion 430. The cooling portion 420 may be disposed between the second medium cover 415 and the filter portion 430. The cooling portion 420 may be formed in the shape of a tube that surrounds a cooling path 424 formed therein. The cooling portion 420 may be thicker than the wrapper 440. The cooling portion 420 may be made of a paper material thicker than that of the wrapper 440. The length L4 of the cooling portion 420 may be equal or similar to the length L2 of the medium 411. The length L4 of each of the cooling portion 420 and the cooling path 424 may be 10 mm. When the stick 400 is inserted into the aerosol-generating device (refer to FIG. 3), at least part of the cooling portion 420 may be exposed to the outside of the aerosol-generating device.

Accordingly, the cooling portion 420 may support the medium portion 410 and the filter portion 430, and may secure the rigidity of the stick 400. In addition, the cooling portion 420 may support the wrapper 440 between the medium portion 410 and the filter portion 430, and may provide a portion to which the wrapper 440 is adhered. In addition, the heated air and aerosol may be cooled while passing through the cooling path 424 in the cooling portion 420.

The filter portion 430 may be composed of a filter made of an acetate material. The filter portion 430 may be disposed at the other end of the stick 400. When the stick 400 is inserted into the aerosol-generating device (refer to FIG. 3), the filter portion 430 may be exposed to the outside of the aerosol-generating device. The user may inhale air in the state of holding the filter portion 430 in the mouth. The length L5 of the filter portion 430 may be 14 mm.

The wrapper 440 may wrap or surround the medium portion 410, the cooling portion 420, and the filter portion 430. The wrapper 440 may form the external appearance of the stick 400. The wrapper 440 may be made of a paper material. An adhesive portion 441 may be formed along one edge of the wrapper 440. The wrapper 440 may surround the medium portion 410, the cooling portion 420, and the filter portion 430, and the adhesive portion 441 formed along one edge of the wrapper 440 and the other edge of the wrapper 440 may be adhered to each other. The wrapper 440 may surround the medium portion 410, the cooling portion 420, and the filter portion 430, but may not cover one end or the other end of the stick 400.

Accordingly, the wrapper 440 may fix the medium portion 410, the cooling portion 420, and the filter portion 430, and may prevent these components from being separated from the stick 400.

A first thin film 443 may be disposed at a position corresponding to the first medium cover 413. The first thin film 443 may be disposed between the wrapper 440 and the first medium cover 413, or may be disposed outside the wrapper 440. The first thin film 443 may surround the first medium cover 413. The first thin film 443 may be made of a metal material. The first thin film 443 may be made of an aluminum material. The first thin film 443 may be in close contact with the wrapper 440, or may be coated thereon.

A second thin film 445 may be disposed at a position corresponding to the second medium cover 415. The second thin film 445 may be disposed between the wrapper 440 and the second medium cover 415, or may be disposed outside the wrapper 440. The second thin film 445 may be made of a metal material. The second thin film 445 may be made of an aluminum material. The second thin film 445 may be in close contact with the wrapper 440, or may be coated thereon.

Accordingly, when a capacitance sensor for recognizing the stick is mounted in the aerosol-generating device, the capacitance sensor may sense whether the stick 400 is inserted into the aerosol-generating device.

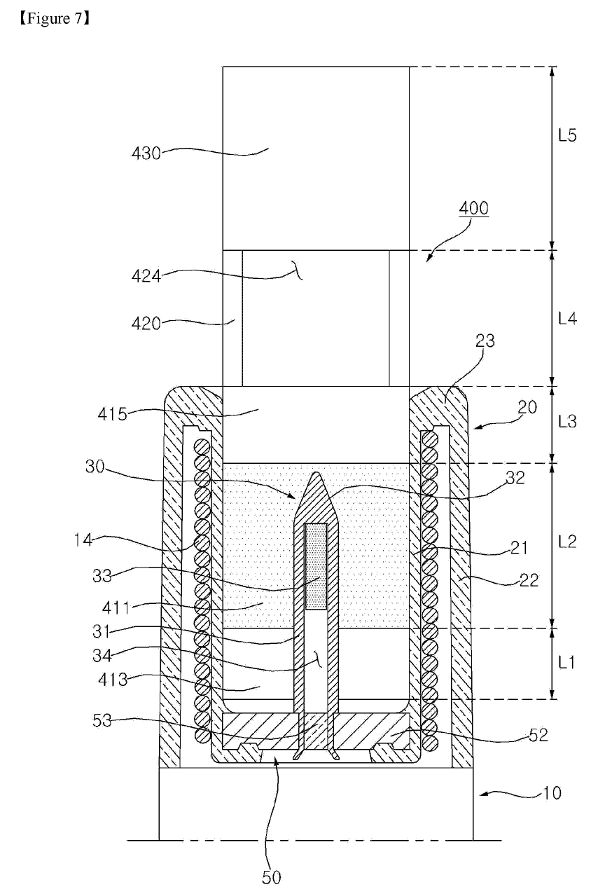

Referring to FIGS. 6 and 7, the upper body 20 or the pipe 20 may include an inner wall 21, an outer wall 22, and an upper wall 23. The inner wall 21 may extend in the upward-downward direction. The inner wall 21 may have a cylindrical shape. The inner wall 21 may surround the periphery of the insertion space 24 having an open top. The outer wall 22 may be spaced apart from the inner wall 21 in the thickness direction to define a space in which the induction coil 14 is disposed. The upper wall 23 may interconnect the upper end of the inner wall 21 and the upper end of the outer wall 22. The upper wall 23 may cover the space between the inner wall 21 and the outer wall 22.

The flange 50 may form the bottom of the pipe 20. The flange 50 may be fixed to the lower end of the pipe 20. The flange 50 may cover the lower portion of the insertion space 24. The heater rod 30 may protrude from the flange 50 into the insertion space 24. lower thermal conductivity

The insulation space 34 in the heater rod 30 may extend upwards from the upper end of the flange 50 by a predetermined length h1. The heater 33 may be spaced upwards apart from the upper end of the flange 50 by the predetermined length h1.

The induction coil 14 may be disposed between the inner wall 21 and the outer wall 22. The induction coil 14 may be wound around the inner wall 21 in the upward-downward direction. The induction coil 14 may surround the insertion space 24 and the heater rod 30. The heater 33 in the heater rod 30 may be caused to generate heat by the induction coil 14. Since the induction coil 14 causes the heater 33 to generate heat, a separate line for connecting the heater 33 to a power source may be unnecessary.

The stick 400 may be inserted into the insertion space 24 through the opening in the insertion space 24. When the stick 400 is inserted into the insertion space 24, the heater rod 30 may be inserted into the stick 400. The heater rod 30 may be inserted into the medium 411 through the first medium cover 413 of the stick 400. The body portion 31 of the heater rod 30 may overlap the first medium cover 413 and the medium 411. The head portion 32 of the heater rod 30 may overlap the medium 411.

The first medium cover 413 may be located on the lower end of the stick 400. When the stick 400 is inserted into the insertion space 24, the heater rod 30 may penetrate the first medium cover 413. When the stick 400 is inserted into the insertion space 24, the first medium cover 413 may approach the upper end of the flange 50, and may be located on the lower end of the insertion space 24. The first medium cover 413 may be located at a height at which the insulation space 34 is located. The insulation space 34 and the first medium cover 413 may overlap each other. The length L1 of the first medium cover 413 may be shorter than or equal to the length h1 of the insulation space 34.

The medium 411 may be located above the first medium cover 413 in the stick 400. When the stick 400 is inserted into the insertion space 24, the heater rod 30 may penetrate the medium 411, and may be inserted into the medium 411. The medium 411 may be located at a height at which the heater 33 is located. The heater 33 and the medium 411 may overlap each other. The heater 33 may heat the medium 411. The length h2 of the heater 33 may be shorter than or equal to the length L2 of the medium 411. The heater 33 may be located in the medium 411. The heater 33 may be located between the upper end of the medium 411 and the lower end thereof. The upper portion of the insulation space 34 may overlap the lower portion of the medium 411.

The second medium cover 415 may be located above the medium 411 in the stick 400. The medium 411 may be located between the first medium cover 413 and the second medium cover 415. When the stick 400 is inserted into the insertion space 24, the heater rod 30 may be located below the second medium cover 415,rather than penetrating the second medium cover 415.

Accordingly, the heater 33 may intensively heat the medium 411, and transfer of heat from the heater 33 to the first medium cover 413 and the second medium cover 415 may be minimized. In addition, it may be possible to prevent the first medium cover 413 from being deformed or damaged by heat and to prevent the medium 411 from leaking from the stick 400. In addition, it may be possible to prevent thermal deformation of a coupling portion between the flange 50 and the heater rod 30 and to improve the structural stability thereof. In addition, it may be possible to increase power efficiency by causing the heater to heat only a necessary portion.

The lower end of the heater 33 may be located at a position higher than the lower end of the medium 411. The upper end of the insulation space 34 may be located at the lower end portion of the medium 411. Accordingly, even if the first medium cover 413 is not present, the amount of carbide generated in the lower end portion of the medium 411 may be reduced, and thus it may be possible to prevent the carbide of the medium 411 from remaining in the device.

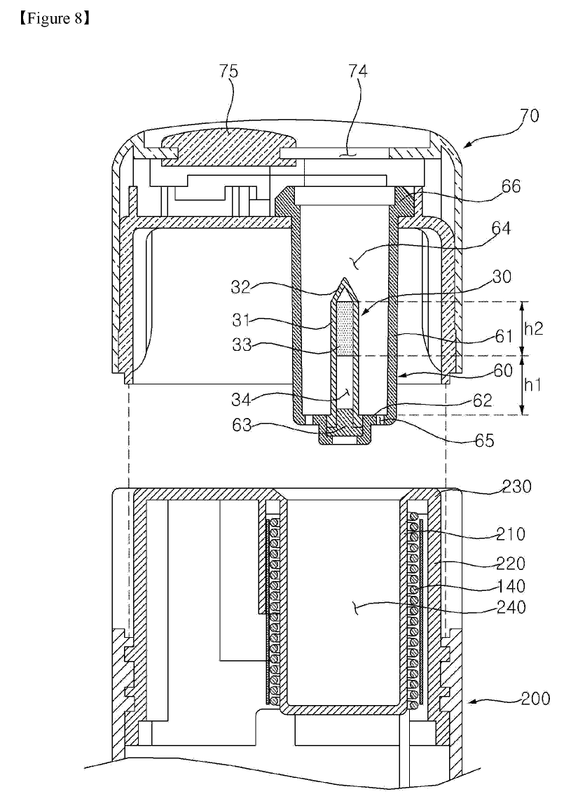

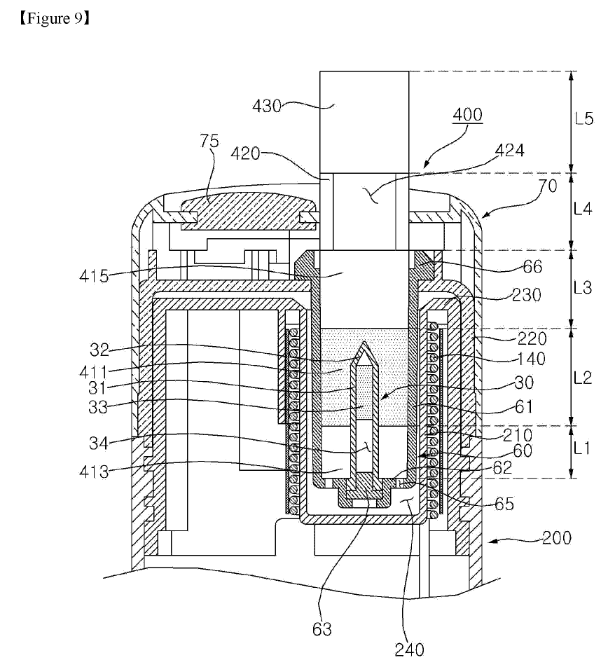

Referring to FIGS. 8 and 9, the upper body 200 may have defined therein an accommodation space 240. The accommodation space 240 may have a cylindrical shape elongated in the upward-downward direction. The inner wall 210 may surround the periphery of the accommodation space 240. The bottom of the accommodation space 240 may be covered, and the top thereof may be open. The outer wall 220 may be spaced apart from the inner wall 210 in the thickness direction to define a space in which the induction coil 140 is disposed. The induction coil 140 may be wound around the inner wall 210. The induction coil 140 may surround the accommodation space 240.

The aerosol-generating device 100 may include an extractor 60. An insertion space 64 may be defined in the extractor 60. The side wall 61 of the extractor 60 may have a cylindrical shape elongated in the upward-downward direction. The side wall 61 may surround the periphery of the insertion space 64. The bottom 62 of the extractor 60 may cover the bottom of the insertion space 64. The upper portion of the insertion space 64 may be open. The extractor 60 may be removably inserted into the accommodation space 240. The extractor 60 may be referred to as a pipe 60.

The heater rod 30 may be fixed to the bottom 62 of the extractor 60. The heater rod 30 may protrude from the bottom 62 of the extractor 60 so as to be elongated in the insertion space 64. The lower end of the insulation space 34 may be open, or may be covered by a cover 63 or the bottom 62 of the extractor 60. A heat absorber such as a phase change material may be inserted into the insulation space 34. The insulation space 34 may be adjacent to the bottom 62 of the extractor 60. The insulation space 34 may be located below the heater 33. The insulation space 34 may be defined at a height between the heater 33 and the bottom 62. The bottom 62 may be referred to as a flange 62.

An upper case 70 may be detachably coupled to the upper body 200. The upper end of the extractor 60 may be coupled to the upper case 70. The upper case 70 may have an opening 74 formed therein. The opening 74 may be formed at a position corresponding to the opening in the insertion space 64. The opening 74 may be located above the opening in the insertion space 64. The opening 74 may communicate with the opening in the insertion space 64. The upper case 70 may include a cap 75. The cap 75 may be movably coupled to the upper end of the upper case 70. The cap 75 may move to open or close the opening 74 and the opening in the insertion space 64.

When the upper case 70 is coupled to the upper body 200, the extractor 60 may be inserted into the accommodation space 240. When the extractor 60 is inserted into the accommodation space 240, the heater rod 30 may be surrounded by the induction coil 140. The heater 33 may be caused to generate heat by the induction coil 140.

The stick 400 may be inserted into the insertion space 64 through the opening 74. The heater rod 30 may be inserted into the stick 400. The first medium cover 413 of the stick 400 may overlap the insulation space 34. The heater 33 may overlap the medium 411. Since this coupling structure has been described above with reference to FIGS. 6 and 7, a detailed description thereof will be omitted.

Referring to FIGS. 1 to 9, an aerosol-generating device in accordance with one aspect of the present disclosure may include a pipe shaped to define an insertion space; a flange covering a bottom of the insertion space; a heater rod coupled to the flange, wherein the heater rod may be elongated and protrudes into the insertion space; a heater disposed in the heater rod and being configured to heat the insertion space, wherein the heater rod may be shaped to include an insulation space that it located below the heater.

In addition, in accordance with another aspect of the present disclosure, the insulation space may comprise a portion formed between a lower end of the heater and at a plane that corresponds to a upper surface of the flange.

In addition, in accordance with another aspect of the present disclosure, the aerosol-generating device may further include an induction coil disposed around a portion of the insertion space and being configured to cause the heater to generate the heat.

In addition, in accordance with another aspect of the present disclosure, the aerosol-generating device may further include a stick shaped to be insertable into the insertion space, the stick comprising a medium provided therein, wherein, when the stick is inserted into the insertion space, the heater may be located at a height that generally corresponds to at least a portion of the medium.

In addition, in accordance with another aspect of the present disclosure, a stick shaped to be insertable into the insertion space, the stick comprising a medium provided therein, wherein, when the stick is inserted into the insertion space, the heater may be located at a height that is higher than a lower end of the medium.

In addition, in accordance with another aspect of the present disclosure, the heater may have a length h2 shorter than the length L2 of the medium.

In addition, in accordance with another aspect of the present disclosure, wherein the stick comprises a medium cover that is located to cover a lower portion of the medium, and wherein, when the stick is inserted into the insertion space, the insulation space may overlap the medium cover.

In addition, in accordance with another aspect of the present disclosure, the aerosol-generating device may further include a heat absorber that is located in the insulation space.

In addition, in accordance with another aspect of the present disclosure, the aerosol-generating device may further include an upper body shaped to define an accommodation space having an open top that is sized to removably receive the pipe; and an induction coil surrounding a portion of the accommodation space and being configured to cause the heater to generate the heat.

In addition, in accordance with another aspect of the present disclosure, the aerosol-generating device may further include an upper case structured to be coupled to the pipe, the upper case shaped to define an opening that is in communication with the insertion space, the upper case being detachably coupled to the upper body; and a cap coupled to the upper case and being positionable to open and close the opening and the insertion space.

In addition, in accordance with another aspect of the present disclosure, the insulation space may comprise a lower thermal conductivity relative to a thermal conductivity of the heater rod.

In addition, an aerosol-generating device in accordance with another aspect of the present disclosure may include a pipe shaped to define an insertion space, wherein the pipe may have an upper portion that is open and allow insertion of a stick into the insertion space; a flange coupled to a lower portion of the pipe and covering a portion of a bottom of the insertion space in cooperation with an inner side of the pipe; a heater rod coupled to the flange, wherein the heater rod may be elongated and protrudes into the insertion space; and a heater disposed in the heater rod and being configured to heat the insertion space, wherein the heater rod may be shaped to include an insulation space that it located below the heater.

In addition, in accordance with another aspect of the present disclosure, an induction coil being configured to cause the heater to generate the heat, wherein the pipe may include an inner wall and an outer wall, and wherein the induction coil may be positioned between the inner wall and the outer wall of the pipe and is disposed around a portion of the insertion space.

Certain embodiments or other embodiments of the disclosure described above are not mutually exclusive or distinct from each other. Any or all elements of the embodiments of the disclosure described above may be combined with another or combined with each other in configuration or function.

For example, a configuration "A" described in one embodiment of the disclosure and the drawings and a configuration "B" described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol-generating device comprising:
a body;
a battery accommodated in the body;
a pipe coupled to the body and having an insertion space open upwardly;
a flange fixed to a lower end of the pipe and defining a bottom of the insertion space;
a heater rod located within the insertion space, protruding from the bottom of the insertion space, and elongated in a vertical direction; and
a heater electrically connected to the battery and disposed within the heater rod,
wherein the heater is spaced upwardly apart from an upper end of the flange.

2. The aerosol-generating device of claim 1, wherein the heater rod comprises:
a body portion having an elongated cylindrical shape; and
a head portion located at an upper end of the body portion and having a shape that gradually narrows upwardly.

3. The aerosol-generating device of claim 2, wherein the body portion of the heater rod surrounds a circumference of the heater.

4. The aerosol-generating device of claim 2, wherein the head portion covers an upper end of the heater.

5. The aerosol-generating device of claim 1, wherein an air layer is located between the heater rod and the heater.

6. The aerosol-generating device of claim 5, further comprising a cover covering a lower end of the air layer.

7. The aerosol-generating device of claim 1, wherein the heater rod is fixed to the flange, protrudes from the flange toward the insertion space, and extends longitudinally in the vertical direction.

8. The aerosol-generating device of claim 1, wherein the heater rod comprises a ceramic.

9. The aerosol-generating device of claim 1, wherein the heater is a resistive heater configured to receive a current from the battery and directly generate heat.

10. The aerosol-generating device of claim 1, wherein when a stick is inserted into the insertion space, the heater rod penetrates an end of the stick and is inserted into the stick.

11. The aerosol-generating device of claim 10, wherein the stick comprises:
a first medium cover located at one end of the stick and comprising paper;
a filter portion located at another end of the stick and comprising acetate;
a second medium cover located between the first medium cover and the filter portion and comprising acetate;
a medium between the first medium cover and the second medium cover; and
a cooling portion between the second medium cover and the filter portion.

12. The aerosol-generating device of claim 11, wherein the first medium cover and the medium extend longitudinally, and
a length of the first medium cover is smaller than a length of the medium.

13. The aerosol-generating device of claim 11, wherein the second medium cover and the medium extend longitudinally, and
a length of the second medium cover is smaller than a length of the medium.

14. The aerosol-generating device of claim 11, wherein when the stick is inserted into the insertion space, the heater rod penetrates the first medium cover and is inserted up to the medium.

15. The aerosol-generating device of claim 11, wherein the heater rod comprises:
a body portion having an elongated cylindrical shape; and
a head portion located at an upper end of the body portion and having a shape that gradually narrows upwardly,
wherein the head portion of the heater rod overlaps the medium in a direction crossing the vertical direction.

16. The aerosol-generating device of claim 12, wherein the heater rod is spaced apart from the second medium cover.

17. The aerosol-generating device of claim 11, wherein the cooling portion comprises a paper tube surrounding a hollow cooling path therein.
